(19) United States
(12) Patent Application Publication
(10) Pub. No.: US 2004/0260573 A1
(43) Pub. Date: Dec. 23, 2004

(54) Method and system for utilization assessment development and management of open space land areas

(76) Inventor: Kathleen M. Schmitt, Gainesville, VA (US)

Correspondence Address: MILES & STOCKBRIDGE PC, 1751 PINNACLE DRIVE, SUITE 500, MCLEAN, VA, 22102-3833, US

(21) Appl. No.: 10/849,907

(22) Filed: May 21, 2004

Related U.S. Application Data
(60) Provisional application No. 60/472,720, filed on May 23, 2003.

(51) Int. Cl. G06F 17/60

(52) U.S. Cl. 705/1

(57) ABSTRACT

A process and system for land development in which existing legacy buildings and open space land areas are retained and re-employed to suit modem markets demands in locations with demographics that are appropriate for the utilization of the buildings and land in mutually beneficial associated commercial activities, at least one of which requires relatively large open space land areas or tracts. The process identifies candidate properties, assesses the utilization and economic potential of candidate properties, and selects a property best suited to the contemplated goals of the development project and the market demographics. The process also identifies commercial activities that may use the open space land and legacy buildings according to modern market demands. The process also supports the formation of an association of these commercial activities, one of which employs the legacy buildings and facilities and at least one other of which requires relatively large areas of open space nearby. In the system, several operational modules are integrated into a comprehensive land use plan, which utilizes any legacy buildings and the association of commercial activities to optimize the land use process.

### RELATED APPLICATIONS

This application claims the benefit of the filing date of provisional application Ser. No. 60/472,720, filed May 23, 2003, and titled “A Method of Optimizing the Development of Open Land Area.”

### FIELD OF THE INVENTION

The present invention relates to land development. More particularly, the present invention relates to a method and system for utilization assessment, development and management of open space land areas.

### BACKGROUND OF THE INVENTION

Land developments include resorts, country clubs, theme housing developments (such as golf communities), sports facilities operated by home owner associations, ski lodges, manor homes converted to museums, bed and breakfast inns, theme resorts and the like. These land developments may provide a combination of housing, accommodations, recreational facilities, entertainment facilities and/or educational facilities. A goal of such a combination may be to enhance the overall experience of the resident or guest. Recently, land developers have sought ways to enhance new housing developments by retaining some agricultural practices and natural resources. These housing developments are often referred to as conservation communities or conservation developments. Examples of conservation communities include Tryon Farm in Indiana and The Fields of St. Croix in Minnesota. Another goal of the developers is cost containment or minimizing the total cost of development of open space. This can be achieved to some extent by dedicating certain land areas as agricultural districts to obtain certain tax benefits provided by a state, such as, for example, the Commonwealth of Virginia.

A limitation of the conventional conservation community models is that they may not provide associated, independent and privately owned commercial operations that utilize large areas of open space; also, these models may not provide a core entity providing common facilities that offer goods and services from associated independent commercial operations.

A further limitation and disadvantage of existing conservation community models from the standpoint of efficient land use, management and development is that they are not based on independent ownership of businesses voluntarily associated with a core business primarily employing facilities rather than open land to provide services both to the associated businesses and the broader market, with at least a partially overlapping clientele and in which businesses make extensive use of the open space land areas from which the community model is formed. Such a core business may provide common facilities, such as conference rooms, marketing programs and support, and some general and administrative support on an as needed basis for the associated independent businesses and community.

A still further limitation of existing conservation community models is that they do not seek to restore the economic value of existing facilities surrounded by relatively large tracts of open space land by supporting commercial use of the land as open space, rather than as residential building sites.

Computers are a common tool used in business evaluation. However, their application to land use planning including property search and evaluation of commercial support functions dedicated to the association of mutually beneficial commercial activities in order to maximize economic value to existing open space land has been limited.

The process of land use planning and land development around metropolitan areas typically raises land values. In some cases, land value becomes so great that prior agricultural uses or maintaining land in its pristine state cannot be economically sustained. The owners of the land sometimes plan for the appreciation of land that was once, and perhaps presently is, employed in various kinds of agriculture as the ultimate recouping of the investment made in the land. Frequently large tracts of open space land are gradually reduced in size by sale and development of parts of the property from time to time. Many such tracts often have one or more legacy buildings remaining, which are deemed incompatible with proposed development and destroyed. These legacy buildings may include houses and ancillary buildings that were originally designed to serve various kinds of commercial agricultural functions.

It is not uncommon for the legacy buildings to have historic or traditional value, and for the part of the property holding such buildings to be among the last of what was once a much larger property to be considered for sale. Many such tracts, with or without the areas containing buildings, are finally marketed and bought with the intention of building new housing. This is often seen to be the best and highest use of such land, as measured by the highest bidders when the tract is being considered for sale. Certainly the financial opportunities in housing or other typical land developments can be great.

The present value of the legacy buildings on the land may seem insignificant in comparison with the potential gain from developing new housing. Even if some of the legacy buildings are retained, or perhaps restored, as part of a plan to develop houses in the direct area, the buildings are left with little more than their value in materials. They remain as memorials of a lifestyle now uncommon. It may be thought progressive, sentimental or at least ecologically and/or politically harmless, to plan to use existing legacy facilities or the less easily built upon open space areas within the tract as some type of amenity or attraction for the housing to be built around them. However, in the conventional conservation community model it is the new housing construction that is relied upon for the profit to be drawn from the investment in such property.

Nevertheless, there is a loss of value to be considered in bypassing the original intention and designs of the land and legacy buildings in some cases. Beyond sentimentality, the open space land and legacy building assets may have a high inherent value in essentially their current state. A process of re-employment of such land and legacy buildings by applying their original design and function to modern market demands rather than the traditional agriculture use may restore their economic value with little or no physical modification.

Legacy buildings frequently may not look like business assets to the modern eye, but they often were originally designed and built primarily to serve the profitable employment of relatively large areas of the immediately surrounding land. For example, a typical farmhouse served much the same or similar functions as those served by any business headquarters today. These include office facilities, customer relations, investor relations, employee relations, cafeteria, staff support and meeting area for proprietors, their colleagues and staff. Surrounding or nearby land and various legacy outbuildings may have served as production facilities, processing facilities, warehousing facilities, equipment maintenance facilities, equipment storage facilities, employee housing and/or employee training facilities.

The value of the legacy buildings as business assets depends on the physical and functional associations among each other and with closely surrounding profit-centered activities requiring relatively large tracts of open space land. As open space areas are reduced in size, these inherent business functions cannot be devoted to agricultural endeavors as profitably as they once may have been. It is therefore sometimes erroneously assumed they no longer have any business asset value.

Since the function of such legacy facilities was essentially to support commercial activity of a kind that requires relatively large areas of open space nearby, the simple act of building houses nearby can be sufficient to destroy their economic value. This is akin to destroying business capital. Through efficient land use planning, many such complexes of legacy facilities and land may be profitably and advantageously re-employed by adapting their original use as centers supporting nearby open space land commercial activities by changing the markets they serve and the business structure under which they operate. Rather than physically or functionally destroying them, the economic potential of such business assets may be retained or even enhanced by applying a new business operation model that seeks to meet the market demands of the modern suburban lifestyle in a rural setting.

What is needed is a process of creating a commercial association of activities that enables the associated commercial actors to offer an economic return predictably higher than strictly agricultural pursuits, and often at least comparable to that of building housing. Potentially quite profitable in itself, however, such a process of association may also offer additional benefits to the wider community by preserving in part or whole larger areas of open space and traditional, if not historic, buildings, profitably employing what may be ecologically delicate areas or land otherwise deemed of no economic value, while enhancing the experience of consumers and the greater community by leaving larger tracts relatively open, yet commercially employed.

Such a process of association also offers desired services to members of nearby and further communities, employment to local job seekers, trade to local vendors, and ongoing business tax revenues to local governments, which are generally more desired than residential property tax revenues. Such a process of association also offers diversification of overall economic risk and business cycle risk by utilizing more than one actor in more than one commercial activity.

In order to efficiently accomplish the re-employment of an open space land tract, which may contain legacy buildings, two processes are needed. First, a process of evaluating particular properties and surrounding areas with the intention of applying the existing or modified legacy buildings, newly built facilities and open space land to modern market demands; and, second, a process of profitably associating, operating and managing commercial activity in the existing legacy facilities and/or newly built facilities by utilizing the immediately surrounding commercial activities of the kind which require relatively large areas of land and also serve modern market demands.

The present invention integrates both of these processes into a single process for land development of open spaces by which facilities and land suitable for forming and implementing an association of commercial activities are identified, particular sites for their potential mix of commercial activities are evaluated, and an association of such commercial activities is formed which will re-employ any existing legacy facilities and/or newly built facilities and land under consideration as bases for associated, mutually beneficial commercial activities suiting current markets demands and demographics. This process also supports task scheduling, facility use allocation, reservations and travel management, transactions of goods and services, intra-association communication, credit and background checks, public communication, financial record keeping and projections, inventory and asset tracking, financial and event reporting, marketing, and other related administrative tasks and records.

Accordingly, it is an object of the present invention to overcome the drawbacks and limitations of conventional land development. An example of such a drawback includes physically or functionally destroying actual or potential tangible and intangible business assets immediately surrounded by larger areas or tracts of available land.

It is also an object of the invention to provide a system that will re-employ or enhance existing legacy facilities to serve at least one immediately surrounding mutually beneficial commercial activity of a sort that may require relatively large open space land areas or tracts.

These and other objects of the present invention are achieved by a process of re-employing legacy buildings and open space land to suit modern markets demands in locations with demographics that are appropriate for the utilization of the facilities and land in mutually beneficial associated commercial activities, at least one of which requires relatively large open space land areas or tracts.

These objects are further achieved by a process, which in its initial phase identifies suitable candidate properties. Once the candidates are identified, their economic potential is assessed. Existing legacy buildings are evaluated for their potential commercial value by modules for planning and development. The cost of building any new facilities that may be needed to support commercial activities is also evaluated.

### SUMMARY OF THE INVENTION

The process of the present invention is initiated with forming an enterprise to oversee, implement, and operate the processes. This enterprise may be a traditional business, a nonprofit organization, or a government organization. The process comprises the steps of identifying facilities and land suitable for forming an association of at least two mutually beneficial commercial activities, at least one of which requires relatively large open space land areas; evaluating the identified sites for the economic potential of associating at those sites at least two commercial activities, a core business that would employ any legacy facilities and/or newly built facilities and at least one associated independent business that may require relatively large amounts of open space land; planning the initiation and operation of the associated commercial activities; implementing the planned commercial activities; and, managing and sustaining the associated commercial activities.

Further, the system provided herein supports these objectives by forming several modules, which are integrated into the land use plan. Events and data involved in the search for suitable properties and commercial opportunities are recorded and tracked in individual modules such as an identification module, a site module, an economic potential module, a site acquisition module and an association formation and management module. Elements of the financial analysis and business projections for particular properties and mixes of potentially profitable commercial opportunities are automated. The system also supports computer implementation and operation of the associated commercial activities by providing task scheduling, facility use allocation, transactions of goods and services, intra-association communication, public communication, financial record keeping and projections, inventory and asset tracking, financial and event reporting, and marketing.

In another aspect, the invention comprises a process for identifying potential actors to engage in commercial activities which require relatively large amounts of open land, and actors to engage in commercial activities employing existing or created facilities which benefit the open land-based commercial activities as well as suit the local market demands; forming an association between at least two such diverse actors; and, implementing the mutually beneficial associated commercial activities.

In another aspect, the invention promotes the resulting associated commercial activities to local and broader markets using a variety of marketing tools; and supports the associated commercial activities by assisting each business to provide services, facilities, and products to each other and to the wider market, such as security, staffing, facility maintenance, purchasing, transportation, communications, scheduling, reporting, billing, and other administrative and support services as selected by each associated actor.

### BRIEF DESCRIPTION OF THE DRAWINGS

Additional advantages of the invention will become apparent upon reading the following detailed description and upon reference to the drawings, in which:

FIG. 1 is a block diagram of an exemplary system for identifying, developing and managing open space land in accordance with the present invention;

FIG. 2 is a block diagram of an exemplary embodiment of an economic potential evaluation module in accordance with the present invention;

FIG. 3 is a block diagram of an exemplary association management module in accordance with the present invention;

FIG. 4 is a flowchart of an exemplary method for identifying, developing and managing open space land in accordance with the present invention:

FIG. 5 is a flowchart showing the step of identifying, evaluating and acquiring open space land in greater detail;

FIG. 6 is a flowchart showing the step of forming an association of businesses in greater detail;

FIG. 7 is a flowchart showing the step of managing and marketing the development in greater detail;

FIG. 8 is a flowchart showing the step of identifying suitable sites in greater detail;

FIG. 9 is a flowchart showing the step of evaluating the economic potential of a particular site in greater detail;

FIG. 10 is a block diagram showing the relationship of the association of businesses with the open space land and legacy facilities;

FIG. 11 is a block diagram showing the relationship of the association of businesses with each other; and

FIG. 12 is a block diagram showing the relationship of each business in the association of businesses with particular members of a family.

### DETAILED DESCRIPTION OF THE PREFERRED EMBODIMENTS

For purposes of illustration, exemplary embodiments are described with reference to specific configurations. Those skilled in the art will appreciate that various changes and modifications can be made without departing from the spirit and scope of the present invention.

The exemplary embodiments of the processes and systems of the present invention described herein provide for an association of at least two commercial activities, at least one of which requires relatively large areas of open space, which enable at least two mutually beneficial commercial activities to employ existing, modified, or created facilities and relatively large areas of open land in commercial activities providing economic return at least comparable to the use of essentially the same facilities and land for housing. The identification of suitable properties and actors as well as overseeing and operating the commercial activities is assisted by software and hardware adapted specifically to the needs of such a process and organization.

While the systems and methods of the present invention are discussed in terms of computer based operation, it should be appreciated that any method of calculating, evaluating, and tracking information, such as human thought, mechanical systems, and/or any present or future developed element(s) capable of implementing the systems and methods of the present invention may be used.

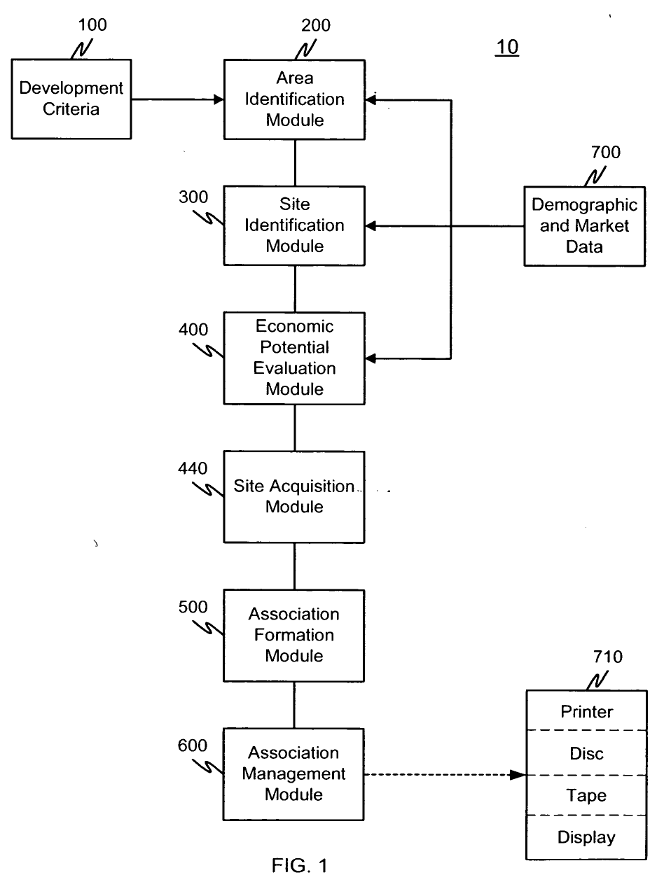

FIG. 1 is a block diagram of an exemplary embodiment of a system 10 for developing open space land in accordance with the present invention. In particular, the system 10 is comprised of an area identification module 200, a site identification module 300, an economic potential evaluation module 400, a site acquisition module 440, an association formation module 500, and an association management module 600. The inputs to the system comprise development criteria 100 and demographic and market data 700, which may be derived from existing databases. The output of the system is a report 710 that may be in the form of a printout, data stored on a tape or disk, and/or presented on a display device.

In operation, the area identification module 200 receives the development criteria 100 and demographic and market data 700. The area identification module 200 then compares the demographic and market data 700 against the development criteria 100 and generates a list of areas that are suitable for development.

The site identification module 300 receives the list of areas suitable for development, the development criteria 100 and the demographic and market data 700. The site identification module 300 compares each site within a suitable area against the development criteria 100 and the demographic and market data 700 and generates a list of suitable development sites within each suitable area.

The economic potential evaluation module 400 receives the list of suitable development sites and the demographic and market data 700. The economic potential evaluation module then evaluates each site according to a list of weighted factors and generates an economic potential index for each site and a list of potential commercial activities that are well suited to the area based on the demographic and market data 700. The sites may then be ranked according to the economic potential index. The site with the most desirable economic potential index is selected for development.

Alternatively, a preselected site may be placed into the system for evaluation by the economic potential evaluation module 400. This may be done in cases where, for example, a developer already has an existing site, or in cases where a certain existing site has other advantageous characteristics. In such cases, the economic potential evaluation module 400 evaluates the site and generates the economic potential index and the list of potential commercial activities that are well suited to the surrounding area based on the demographic and market data 700.

The site acquisition module 440 receives the selected site from the economic potential evaluation module 400. The site acquisition module 440 analyzes the financing options and generates a financing plan that is best suited for the selected site. The site acquisition module may also generate any agreements or contracts required for the acquisition of the selected site.

The association formation module 500 receives the selected site and the list of potential commercial activities that was generated by the economic potential evaluation module 400. The association formation module 500 evaluates commercial actors in each of the commercial activities and identifies the most well suited actors to forma an association with in the development. The association formation module 500 then generates any agreements necessary to implement the association between the commercial actors.

The association management module 600 receives the list of associated commercial activities and the terms of the association agreements. The association management module 600 monitors and manages the finances of the association to ensure that all associated businesses are performing according to their respective agreements and that the association is operating in a sustainable manner. If any member of the association of commercial activities is not performing according to the agreement, or if the association has become unsustainable, the association management module 600 will identify the problem and bring it to the attention of management.

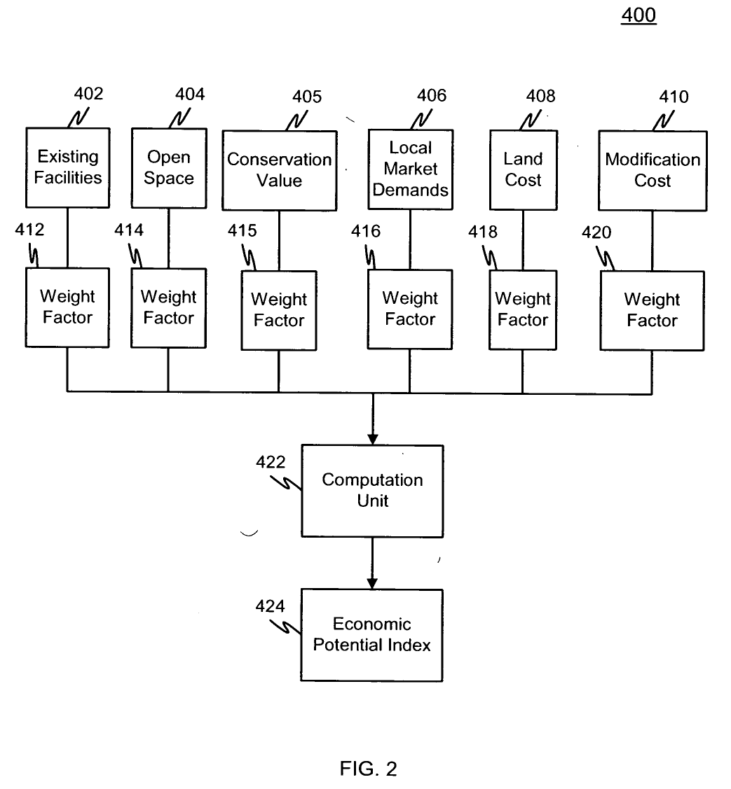

FIG. 2 is a block diagram showing an exemplary economic potential evaluation module 400 in greater detail. In particular, the economic potential evaluation module 400 is comprised of criteria factors based on the site being evaluated and the demographic and market data 700, weight factors, a computation unit 422, and an output economic potential index 424. In the exemplary embodiment shown, the criteria factors comprise existing facilities 402, open space 404, conservation value 405, local market demand 406, land cost 408 and modification cost 410 factors. There is a weight factor (412-420) that corresponds to each criteria factor respectively.

In operation, the computation unit 422 receives the criteria factors (402-410) and weight factors (412-420). The computation unit then multiplies each criteria factor by its corresponding weight factor and cumulatively sums the results of the multiplications. The resulting total is the economic potential index 424. By ranking sites according to their respective economic potential indices, the economic evaluation module 400 may produce an ordered list of sites from most suitable to least in terms of economic potential. The ordered list can be used by the system to select the site to develop.

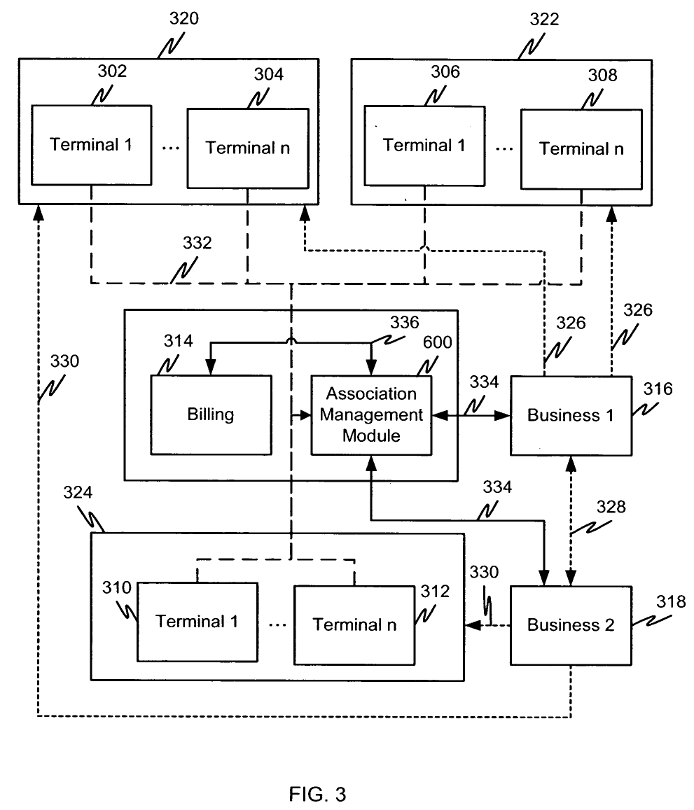

FIG. 3 shows a block diagram of a portion of an exemplary association management module in greater detail. In particular, the association management module 600 is connected to terminals (302-312) in each of the facilities (320-324) by links 332. The independent businesses (316 and 318) are connected to the association management module 600 by links 334. The independent businesses (316 and 318) are connected to each other via link 328. The association management module 600 is connected to the billing module 314 by link 336. The links may be wired, such as, for example, Ethernet; wireless, such as, for example, radio frequency; and/or any known or later developed element(s) that is capable of communicating data.

In operation, a terminal, for example terminal 1 302 in facility 1 320, may request certain goods or services. The terminals may be point-of-sale terminals and/or the like. The request is transmitted via link 332 to the association management module 600, which determines that the request should be routed to independent business 1 316 and the request is routed there via link 334. Upon receiving the request, independent business 1 316 provides the requested goods or services 326.

Further, the independent business (316 and 318) may request goods or services from the association management module 600 via links 334. The association management module 600 may then route the request to the appropriate independent business for fulfillment. The independent businesses (316 and 318) may provide goods or services 328 to each other.

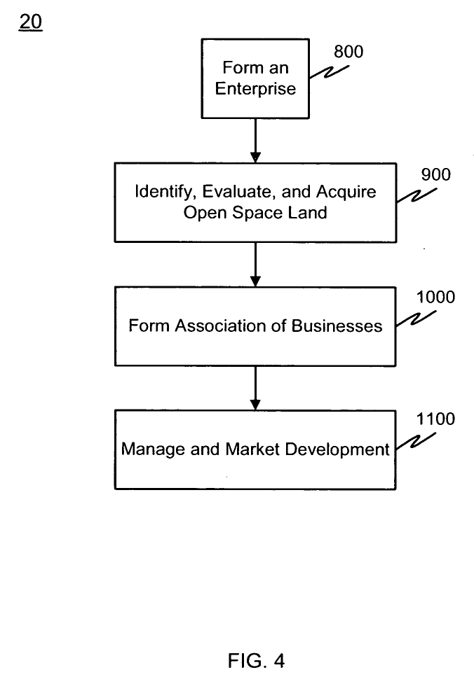

FIG. 4 is a flowchart of an exemplary method 20 for identifying, developing and managing open space land in accordance with the present invention. In particular, the method 20 comprises forming an enterprise 800 to develop and manage open space land development and/or to operate the core business; identifying, evaluating and acquiring the open space land 900; forming an association of independent businesses 1000 with each business owning a portion of the open space land and/or facilities depending on the nature of the business; and managing and marketing the development 1100 and association of businesses.

In operation, the method begins at step 800, forming an enterprise. The enterprise may be a traditional business, a nonprofit organization, a civic organization or a government organization. The enterprise may be a newly formed one, or an existing enterprise that has resolved to undertake the method of developing open space land according to he present invention. For the sake of clarity, the description will focus on a traditional business. However, it should be appreciated that the same method could be applied to other types of enterprises. Once an enterprise is formed, or an existing enterprise is utilized, control continues to step 900.

In step 900, potential areas and sites are identified, evaluated, and the most suitable site is acquired. This step will be discussed in greater detail below. Once step 900 has been completed, control continues to step 1000.

In step 1000, an association of businesses is formed. These businesses are in commercial areas identified in step 900. The businesses enter into ownership and usage rights agreements, and form an association, where at least one business primarily utilizes facilities and at least one business primarily utilizes open space land. Each business may be independently owned and operated. There is a core business, which is typically owned by the enterprise that is developing the land and there are one or more associated businesses. Once step 1000 has been completed, control continues to step 1100.

In step 1100, the enterprise manages and markets the development. Control remains in this step, as it is an ongoing step. In step 1100, the enterprise manages the association of businesses, markets the goods and services of the businesses, and seeks to maintain an economically sustainable development with a return at least as good as the return provided by building housing on the open space land.

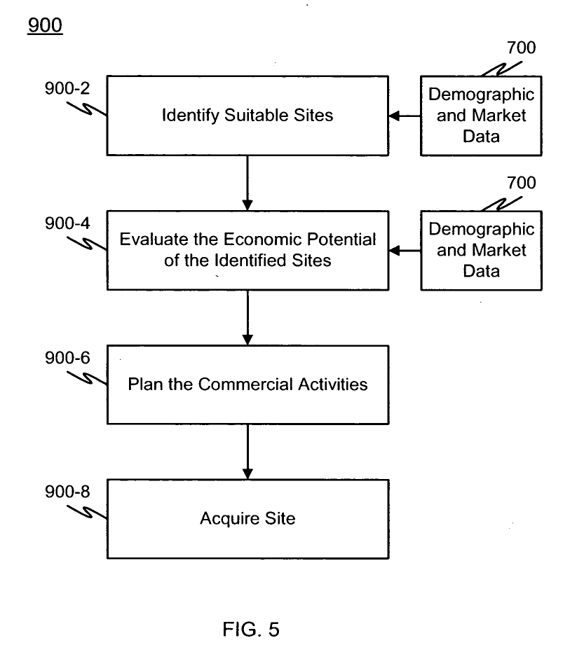

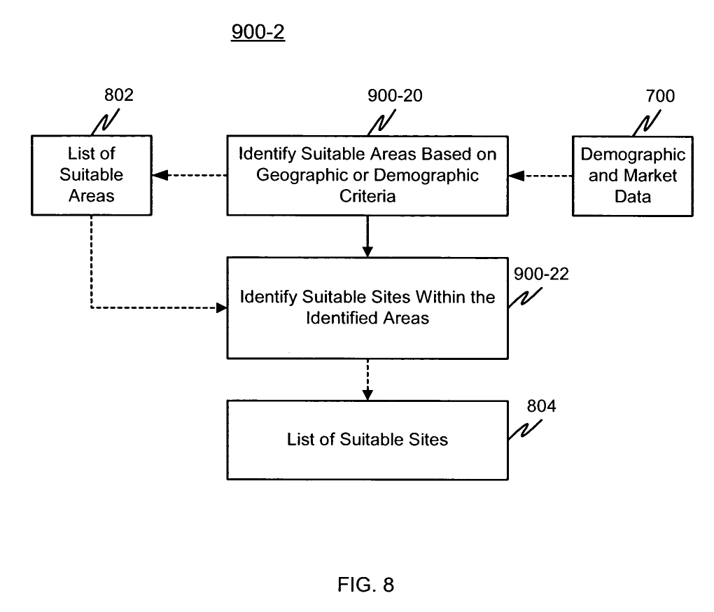

FIG. 5 shows step 900, identifying, evaluating and acquiring the open space land in greater detail. In particular, step 900, begins with sub-step 900-2, identifying suitable sites. Step 900-2 receives as input demographic and market data 700. Sub-step 900-2 is shown in greater detail in FIG. 8, described below. Based on this data, sites that are suitable for development are identified and control continues to sub-step 900-4.

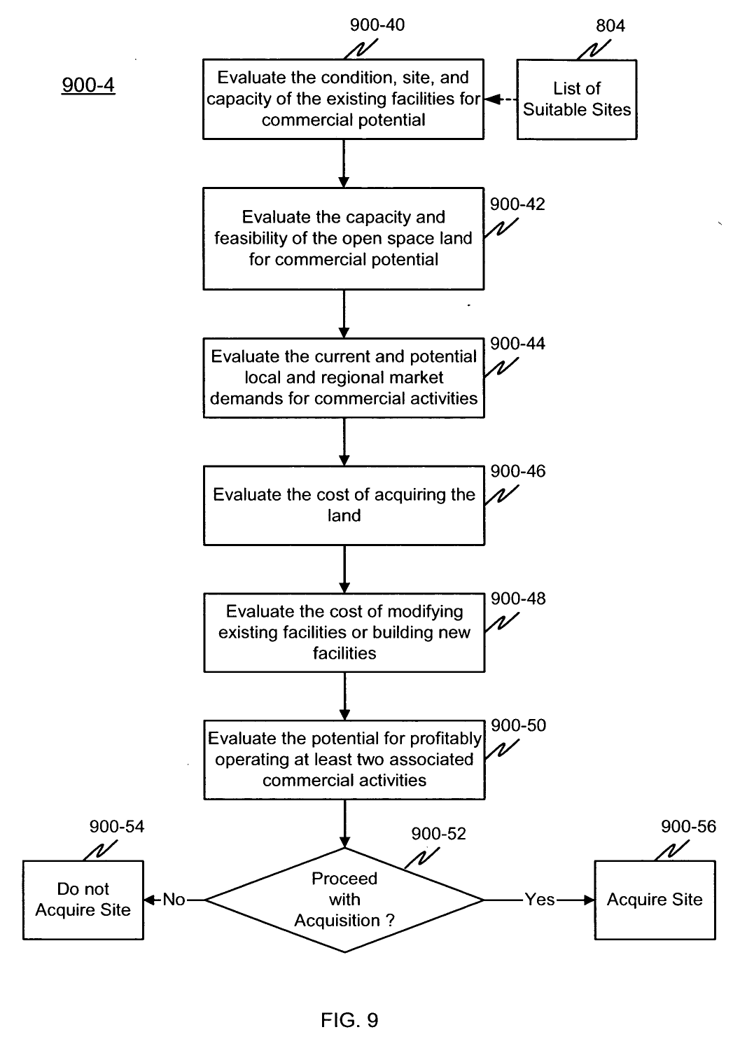

In sub-step 900-4, the economic potential of the sites identified in sub-step 900-2 is evaluated. Sub-step 900-4 also receives demographic and market data 700. Based on the demographic and market data 700, the most suitable site, in terms of economic potential, is selected. Sub-step 900-4 is shown in greater detail in FIG. 9, described below. Once sub-step 900-4 is complete, control transfers to sub-step 900-6.

In sub-step 900-6, the commercial activities are planned. The commercial activities are based on the economic potential evaluation sub-step 900-4. The planning of the commercial activities includes specific and general analysis of the potential to profitably operate the contemplated businesses on the open space land. This includes a more detailed financial and market demand analysis of each of the commercial activities. The planning phase further comprises identifying specific commercial actors, vendors, contractors, furniture and fixtures, electronic equipment, software and hardware, and staff and any other products and services needed for the commercial activities. Once the commercial activities have been planned, sub-step 900-6 is complete and control continues to sub-step 900-8.

In sub-step 900-8, the open space land site is acquired. The acquisition of the site is aided by the economic potential evaluation performed in sub-step 900-4 and the commercial activity planning performed in sub-step 900-6. Once sub-step 900-8 is complete, the sub-steps of step 900 are complete and control continues to step 1000 of FIG. 4.

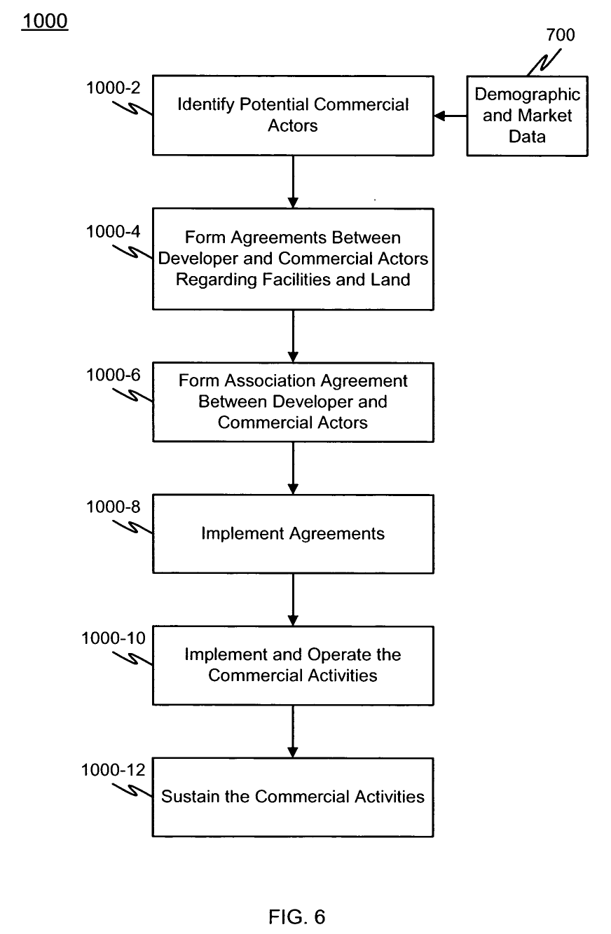

FIG. 6 shows step 1000, forming an association of businesses, in greater detail. In particular, step 1000 begins with sub-step 1000-2. In sub-step 1000-2, potential commercial actors are identified. The commercial actors are those that may engage in the commercial activities planned in sub-step 900-6, described above. Sub-step 1000-2 further comprises identifying potential actors to engage in commercial activities which require relatively large amounts of open space land, and actors to engage in commercial activities employing existing or created facilities which, in addition to other operations, benefit the open space land-based commercial activities to suit the local market demands. Once the potential commercial actors have been identified, sub-step 1000-2 is complete and control continues to sub-step 1000-4.

In sub-step 1000-4, agreements are formed between the developing enterprise and the commercial actors regarding facilities and land. The commercial actors may acquire portions of the open space land or facilities, depending on the nature of the business that they will operate. The agreements set forth the terms of ownership and the rights of use for the other non-owned portions of the development, as well as the rights of use of any common land or facilities. Once the facility and land agreements have been finalized, sub-step 1000-4 is complete and control continues to step 1000-6.

In sub-step 1000-6, an association agreement is formed between the developing enterprise, the core business and the independent businesses. The association agreement sets forth the terms of the association relationship amongst the businesses. Further, the agreements may stipulate that each commercial activity will provide their goods and services to each other associated commercial actor at rates, times, and terms at least as favorable as those offered to the public or their typical customers. Once the association agreements have been finalized, sub-step 1000-6 is complete and control continues to sub-step 1000-8.

In sub-step 1000-8, the facility and land agreements and the association agreements are implemented. Sub-step 1000-8 further comprises executing any contracts and agreements necessary for the specific facilities and commercial activities; creating the legal entities and executing the legal agreements necessary to initiate and operate the specific commercial activities; developing operating procedures and policies needed for initiating and operating the specific commercial activities; preparing the common facilities and the provision of services among the associated commercial activities; and planning and preparing the electronic and operational systems and activities necessary for the commercial activities to operate as providers of products and services to each other. Once sub-step 1000-8 is complete, control continues to sub-step 1000-10.

In sub-step 1000-10, the commercial activities, comprising the core business and the independent businesses are implemented and begin to operate. Sub-step 1000-10 further comprises: implementing and modifying as needed a plurality of marketing and promotional possibilities for the specific commercial activities planned; implementing and modifying as needed the agreements, contents, performance, and activities of specific commercial actors, vendors, contractors, furniture and fixtures, electronic equipment, software and hardware, and staff and any other products and services needed for the commercial activities; implementing and modifying as needed any contracts and agreements necessary for the specific facilities and commercial activities planned; implementing and modifying as needed the legal agreements necessary to initiate and operate the specific commercial activities planned; implementing and modifying as needed operating procedures and policies needed for initiating and operating the specific commercial activities planned; implementing the use of common facilities and provision of goods services among the associated commercial activities; and implementing and modifying as needed the electronic and operational systems and activities necessary for the commercial activities to operate as providers of goods and services to each other. Once sub-step 1000-10 is complete, control continues to sub-step 1000-12.

In sub-step 1000-12, the commercial activities, comprising the core business and the independent businesses are sustained. Sub-step 1000-12 further comprises: continuing, expanding, or otherwise modifying as needed a plurality of marketing and promotional possibilities for the specific commercial activities planned; continuing, expanding, or otherwise modifying as needed agreements, contents, performance, and activities of specific commercial actors, vendors, contractors, furniture and fixtures, electronic equipment, software and hardware, and staff and any other products and services needed for the commercial activities; continuing, expanding, or otherwise modifying as needed any contracts and agreements necessary for the specific facilities and commercial activities planned; continuing, expanding, or otherwise modifying as needed the legal agreements necessary to initiate and operate the specific commercial activities planned; continuing, expanding, or otherwise modifying as needed operating procedures and policies needed for initiating and operating the specific commercial activities planned; continuing, expanding, or otherwise modifying as needed the use of common facilities and provision of services among the associated commercial activities; and continuing, expanding, or otherwise modifying the electronic and operational systems and activities necessary for the commercial activities to operate as providers of goods and services to each other. The core business may provide activities and systems including, but not limited to, staffing, facility maintenance, purchasing, transportation, communications, scheduling, billing, and other administrative and support services as voluntarily selected and used as desired by each independent business in the association. Once sub-step 1000-12 is complete control continues to step 1100, shown in FIG. 4.

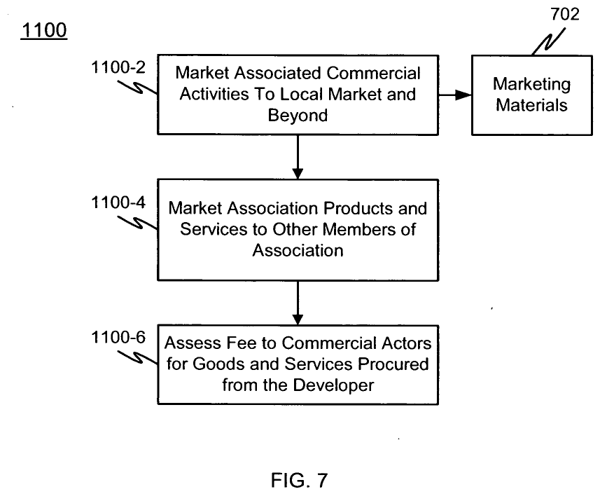

FIG. 7 shows step 1100, managing and marketing the development, in greater detail. In particular, step 1100 begins with sub-step 1100-2. In sub-step 1100-2, the products and services of the association of commercial activities are marketed to the local area and beyond. Sub-step 1000-2 further comprises researching a plurality of marketing and promotional possibilities for the specific commercial activities. Marketing materials 702 are produced as a result of sub-step 1100-2. Control then continues to sub-step 1100-4.

In sub-step 1100-4, the products and services of the association of businesses are marketed to one another. For example, the association may hold regular meetings, at which a particular member may describe their products or services in detail so as to inform the other association member of the availability of the products or services from within the association. Control then continues to sub-step 1100-6.

In sub-step 1100-6, the core business optionally assesses a fee on a regular basis to the independent business for the goods or services procured from the core business. Once sub-step 1100-6 is complete control continues back to step 1100-2. Step 1100 is a continuous step in the process and is not one which is terminal in nature. The actions performed in step 1100 will likely be repeatedly performed throughout the operation of the development.

FIG. 8 shows sub-step 900-2 in greater detail. In particular, sub-step 900-2 begins with sub-step 900-20, identifying suitable areas based on geographic or demographic criteria and which contain facilities and land suitable for forming an association of at least two mutually beneficial commercial activities, at least one of which requires relatively large areas of open space land. Sub-step 900-20 receives as input demographic and market data 700. As a result, sub-step 900-20 generates a list of suitable areas 802. Once sub-step 900-20 is complete, control continues to sub-step 900-22.

In sub-step 900-22, suitable sites are identified. The suitable sites are identified from within the areas in the list of suitable areas 802. The result of sub-step 900-22 is a list of suitable sites 804. The list of suitable sites 804 is used during the economic potential evaluation sub-step 900-4. Once the list of suitable sites 804 has been generated, sub-step 900-2 is complete and control continues with sub-step 900-4.

FIG. 9 shows sub-step 900-4 in greater detail. In particular, sub-step 900-4 beings with sub-step 900-40. In sub-step 900-40, the list of suitable sites 804 is received as input and the condition, site and capacity are evaluated for commercial potential. Further, sub-step 900-40 comprises evaluating the condition, site, and capacity of the existing facilities for commercial activity that may benefit nearby commercial activity of a kind requiring relatively large areas of open land. The site, potential is quantified as a numeric factor and stored for later use. Once sub-step 900-40 is complete, control then continues to sub-step 900-42.

In sub-step 900-42, the open space land is evaluated for capacity and commercial potential by evaluating the capacity and feasibility of using nearby open space land for commercial activity of a kind requiring relatively large areas of open space land. The open space potential is quantified as a numeric factor and stored for later use. Once sub-step 900-42 is complete, control then continues to sub-step 900-44.

In sub-step 900-44, the current and potential local and regional market demands for goods and services are evaluated. Further, sub-step 900-44 comprises evaluating the current and potential local and area market demand for commercial activities, at least one of which of a kind requiring relatively large areas of open land. The market demand is quantified as a numeric factor and stored for later use. Once sub-step 900-44 is complete, control then continues to sub-step 900-46.

In sub-step 900-46, the cost of the open space land and facilities is evaluated. The cost of the land is quantified as a numeric factor, which may be normalized, and stored for later use. Once sub-step 900-46 is complete, control then continues to sub-step 900-48.

In sub-step 900-48, the type and cost of modifying existing facilities or creating new facilities to meet market demand is estimated. The cost of modifying the existing facilities and/or building new facilities is quantified as a numeric factor, which may be normalized, and stored for later use. Once sub-step 900-48 is complete, control then continues to sub-step 900-50.

In sub-step 900-50, the potential for profitably operating at least two commercial activities on the open space land site is evaluated. Further, sub-step 900-50 comprises evaluating the general and specific potential for operating profitability of at least two associated commercial activities under the estimated terms of acquisition of the property, and/or any rights necessary to set up commercial activities on the site, plus the estimated financing of planned modifications or additions to facilities. The profitability potential of the commercial activities is quantified as a numeric factor and stored for later use. Once sub-step 900-50 is complete, control then continues to sub-step 900-52.

In sub-step 900-52, each of the economic factors stored in sub-steps 900-40 through 900-50 are used. There is a weight factor that corresponds to each of the economic factors calculated in sub-steps 900-40 through 900-50. The weight factors are used to assign a relative importance to each of the economic factors. The economic factors 900-40 through 900-50 are each multiplied by their respective weight factors. The results of the multiplications are summed and stored as an economic potential index value. In sub-step 900-52, the economic potential index factor is compared against a threshold value and/or the economic potential index factors of the other sites. If the site has a suitable economic potential index factor then control will proceed to sub-step 900-56, acquiring the site. Otherwise, control will transfer to sub-step 900-54, where the site is not acquired.

If there are any other sites to evaluate, control may return to sub-step 900-40 to begin again the economic potential evaluation with a different site, or control may continue to sub-step 900-6 is a property is to be acquired. Alternatively, if no sites met the threshold economic potential index requirement, then the process may end and the development criteria and other considerations may be re-evaluated.

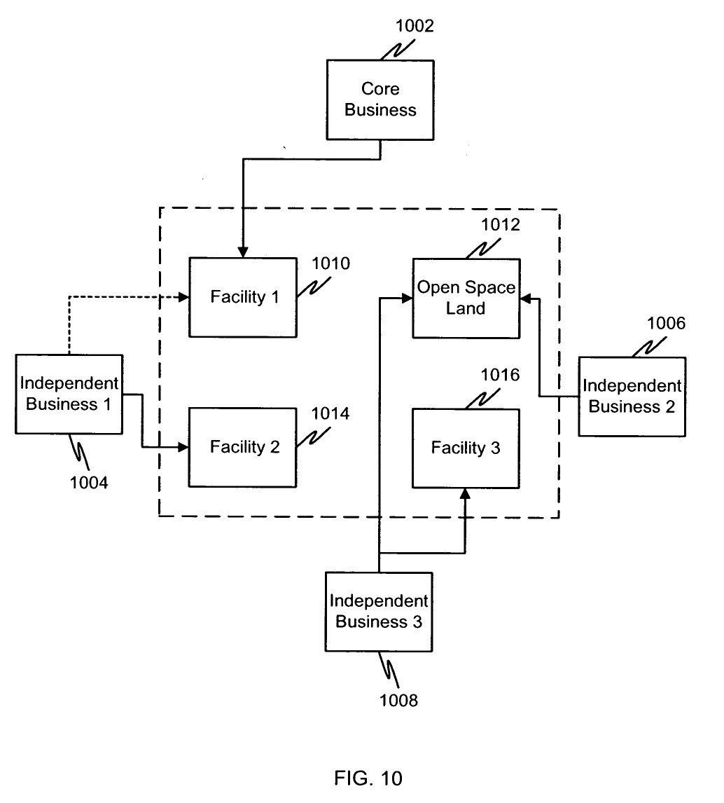

FIG. 10 is a block diagram showing the relationship between the core business, the independent businesses in the association, and the open space land and facilities. The facilities may be legacy facilities that were already present on the development and have been modified to suit modern commercial uses, and/or newly built facilities for the purpose of commercial activities. In particular, in the exemplary embodiment shown in FIG. 10, the core business 1002 owns and utilizes facility 1 1010. Independent business 1 1004 owns and utilizes facility 2 1014 and, through agreement with the core business 1002, occasionally utilizes facility 1 1010. Independent business 2 1006 owns and utilizes a portion of the open space land 1012. Independent business 3 1008 owns and utilizes a portion of the open space land 1012 and owns and utilizes facility 3 1016. FIG. 10 shows one possible arrangement of facilities, land and business utilization and ownership in accordance with the present invention. However, it should be appreciated that many different configurations of ownership and utilization of facilities and land are possible according to the contemplated development goals and objectives.

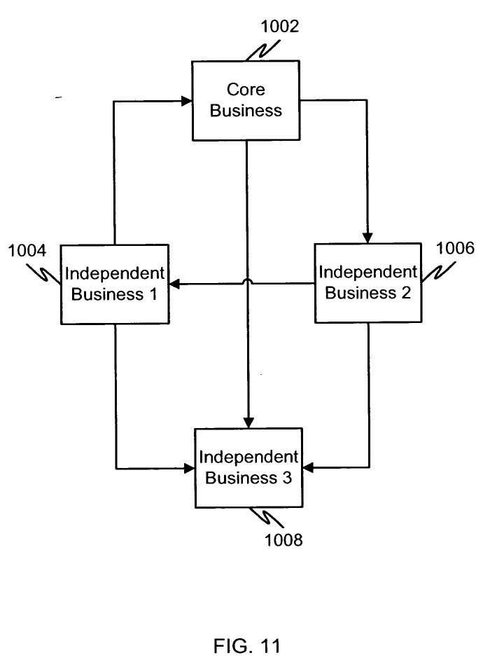

FIG. 11 is a block diagram showing the relationship between the businesses in the association. In particular, the core business 1002 has established an association with the independent businesses (1004, 1006 and 1008). Further, each of the independent businesses (1004, 1006 and 1008) has established a relationship with the other businesses (1004, 1006 and 1008).

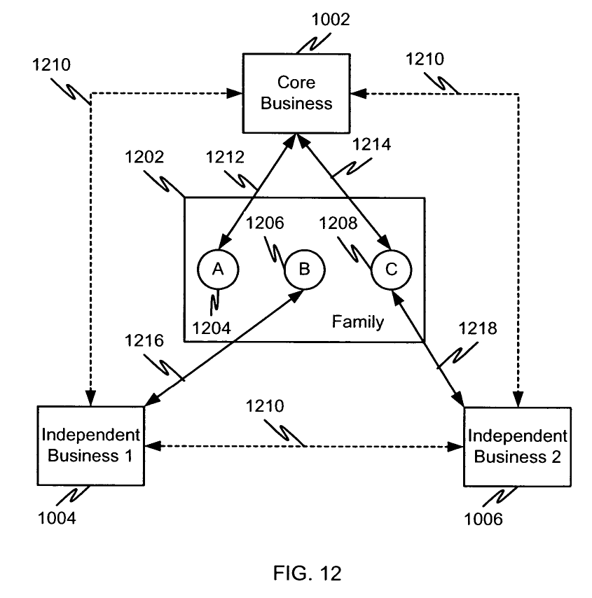

FIG. 12 is a block diagram showing the relationship between the associated businesses and individual members of a family. In particular, an association of businesses comprises a core business 1002, an independent business 1 1004 and an independent business 2 1006. A family 1202 comprises family member A 1204, family member B 1206 and family member C 1208.

In operation, the core business 1002 provides goods or services 1212 to family member A 1204. The core business 1002 also provides goods or services 1214 to family member C 1208. Independent business 1 1004 provides goods or services 1216 to family member B 1206. Independent business 2 1006 provides goods or services to family member C 1208. Additionally, the core business may provide goods or services 1210 to the independent businesses (1004 and 1006). Independent business 1 1004 and independent business 2 1006 may provide goods or services 1210 to each other. FIG. 12 illustrates the ability of an association of business to meet the demands of different members of a family in one development. The system and methods of the present invention ensure that the association of businesses will meet the market demand. Providing mutually a mutually beneficial association of businesses that meets the demands of the various members of a family may create a more productive, enjoyable and rewarding development for customers to frequent.

As is evident from the above description of the embodiments of the systems and methods of the present invention, the invention enables at least two mutually beneficial commercial activities to provide economic return at least comparable to that derived from using essentially equivalent facilities and land for housing, by employing existing, modified or created facilities and relatively large areas of open land in mutually beneficial commercial activities, by identifying and evaluating potential sites, by associating the commercial activities to reduce each commercial activity's capital and operating expense outlays while simultaneously enabling them to offer a wider range of services to their particular clientele, by commonly accessing local and broader markets, and by providing some common facilities and support and administrative services to the associated commercial activities at a fee less than the typical cost of use of all facilities, goods, and services, had they been procured from another source. The automated system provided herein also ease each commercial operator's operating tasks by simplifying many record keeping, scheduling, communication, and management tasks, to the extent they choose to take advantage of the modules of automating services offered by the overseeing entity (i.e. the core business).

As is also evident from the above description, such a process of association of commercial activities, at least one of which requires relatively large areas of open land, enables the commercial actors to provide an economic return at least comparable to that potentially derived from developing essentially equivalent facilities and land for housing. The process enables such an association to offer additional benefits to the wider community by preserving in part or whole relatively larger areas of open space and traditional if not historic legacy buildings, profitably employing what may be ecologically delicate areas or land otherwise deemed of no economic value, and enhancing the urban or suburban experience by leaving larger tracts relatively open.

Such a process of association also offers desired services to members of nearby and further communities, employment to local job seekers, trade to local vendors, and ongoing business tax revenues to local governments, which may be generally more desired than residential property tax revenues. Such a process of association also offers diversification of overall economic risk and business cycle risk by utilizing more than one actor in more than one commercial activity.

It will be apparent to those skilled in the art that various modifications and variations can be made in the processes of the present invention without departing from the scope or spirit of the invention. Accordingly, it is intended by the foregoing description to provide non-limiting examples of the process and system of the invention and resort should be made to the appended claims to ascertain the full importance measures of the inventive features.

What is claimed is:

1. A system for developing open space land comprising:
an area identification module having an input and an area identification output;
a site identification module connected to the area identification output of the area identification module and having a site identification output;
an economic potential evaluation module connected to the site identification output and having an economic potential evaluation output;
a site acquisition module connected to the economic potential evaluation output;
an association formation and management module adapted to receive the output of the economic potential evaluation module and to form an association of businesses, at least one of which utilizes open space land, and at least one of which utilizes a facility; and
an association management module.

2. The system of claim 1, wherein the area identification module receives development criteria and demographic data as input and produces as an output a list of potential areas for development.

3. The system of claim 1, wherein the site identification module receives demographic data and a selected area as input from the area identification module output and produces as an output a list of potential sites for development.

4. The system of claim 1, wherein the economic potential evaluation module receives demographic data and the list of potential sites from the output of the site identification module for development as input to the economic potential evaluation module.

5. The system of claim 1, wherein the economic potential evaluation module further comprises:
an input register for each of existing facility capacity, open space land capacity, local market demand, land cost, and facility modification cost values;
a weight factor register corresponding to each of the existing facility capacity, open space land capacity, local market demand, land cost, and facility modification cost registers; and
a multiplication and summing unit multiplying each of the input register values by its corresponding weight factor value and summing the results into an economic potential index register.

6. The system of claim 2, wherein the economic potential evaluation module further comprises:
an input register for each of existing facility capacity, open space land capacity, local market demand, land cost, and facility modification cost values;
a weight factor register corresponding to each of the existing facility capacity, open space land capacity, local market demand, land cost, and facility modification cost registers; and
a multiplication and summing unit multiplying each of the input register values by its corresponding weight factor value and summing the results into an economic potential index register.

7. The system of claim 3, wherein the economic potential evaluation module further comprises:
an input register for each of existing facility capacity, open space land capacity, local market demand, land cost, and facility modification cost values;
a weight factor register corresponding to each of the existing facility capacity, open space land capacity, local market demand, land cost, and facility modification cost registers; and
a multiplication and summing unit multiplying each of the input register values by its corresponding weight factor value and summing the results into an economic potential index register.

8. The system of claim 4, wherein the economic potential evaluation module further comprises:
an input register for each of existing facility capacity, open space land capacity, local market demand, land cost, and facility modification cost values;
a weight factor register corresponding to each of the existing facility capacity, open space land capacity, local market demand, land cost, and facility modification cost registers; and
a multiplication and summing unit multiplying each of the input register values by its corresponding weight factor value and summing the results into an economic potential index register.

9. The system of claim 1, wherein a site is selected based on the most desirable economic potential index.

10. The system of claim 1, wherein the association formation and management module further comprises:
an order entry system connecting each business in the association to each other;
an order entry system connecting the customers of each business in the association to a central business; and
a billing system allowing the central business to charge each customer for their orders from the central business and associated businesses.

11. The system of claim 2, wherein the association formation and management module further comprises:
an order entry system connecting each business in the association to each other;
an order entry system connecting the customers of each business in the association to a central business; and
a billing system allowing the central business to charge each customer for their orders from the central business and associated businesses.

12. The system of claim 3, wherein the association formation and management module further comprises:
an order entry system connecting each business in the association to each other;
an order entry system connecting the customers of each business in the association to a central business; and
a billing system allowing the central business to charge each customer for their orders from the central business and associated businesses.

13. The system of claim 4, wherein the association formation and management module further comprises:
an order entry system connecting each business in the association to each other;
an order entry system connecting the customers of each business in the association to a central business; and
a billing system allowing the central business to charge each customer for their orders from the central business and associated businesses.

14. The system of claim 5, wherein the association formation and management module further comprises:
an order entry system connecting each business in the association to each other;
an order entry system connecting the customers of each business in the association to a central business; and
a billing system allowing the central business to charge each customer for their orders from the central business and associated businesses.

15. A method of developing an open space land area comprising:
forming an enterprise by a developer to oversee and implement the development of the open space land area;
identifying, evaluating, and acquiring the open space land area;
forming an association of businesses for commercial activity in the open space land area developed; and
managing and marketing a development on the open space land area.

16. The method of claim 15, wherein the step of identifying, evaluating, and acquiring an open space land area comprises:
identifying suitable sites from among available undeveloped open space land areas;
evaluating the economic potential of each suitable site;
selecting the most suitable site;
planning the association of commercial activities that will meet the market demands of the area surrounding the most suitable site; and
acquiring the most suitable site.

17. The method of claim 16, wherein the step of identifying suitable sites comprises:
identifying areas suitable for development based on geographic or demographic criteria;
identifying sites suitable for development within the areas suitable for development; and
generating a list of suitable sites for economic potential evaluation.

18. The method of claim 16, wherein the step of identifying suitable sites comprises using a pre-selected undeveloped site as the only suitable site for economic potential evaluation.

19. The method of claim 15, wherein the step of forming an association of businesses comprises:
identifying commercial actors that provide products or services that meet the market demands for the planned association of commercial activities while utilizing open space land and existing facilities;
forming usage agreements between the developer and the commercial actors regarding open space land and facilities use rights; and
forming association agreements between the developer and the commercial actors.

20. The method of claim 19, further including the steps of:
implementing the usage agreements and association agreements;
implementing and operating the association of businesses; and
sustaining the operation of the association of businesses.

21. The method of claim 20, wherein the step of implementing and operating the association of businesses comprises at least one of:
providing task scheduling;
allocating facility usage;
transacting goods and services;
providing intra-association communication;
providing public communication;
keeping financial records;
making financial projections;
tracking inventory and assets;
reporting financial data and events; and
marketing.

22. The method of claim 20, wherein the step of identifying commercial actors that provide products or services that meet the market demands while utilizing open space land and existing facilities comprises:
identifying first actors having sufficient financial resources to engage in commercial activities which require relatively large amounts of open land and large amounts of investment capital;
identifying second actors to engage in commercial activities employing existing or created facilities which benefit commercial activities on the open land as well as suit the local market demands;
forming an association between at least two said first and second actors; and
implementing mutually beneficial associated commercial activities for the development of the open space land area.

23. The method of claim 15, wherein the step of managing and marketing a development comprises:
marketing the association of businesses to the local, regional, or national markets;
marketing the products or services of each member of the association of businesses to each other member; and
assessing a fee to each business in the association of businesses for goods and services procured from the developer.

24. The method of claim 16, wherein the step of evaluating the economic potential of each suitable sites comprises:
evaluating the condition and capacity of any existing facilities on the site;
evaluating the capacity and potential of the open space land;
evaluating the current and potential market demands for commercial activities in the local or regional area;
evaluating the cost of acquiring the land;
evaluating the cost of modifying existing facilities or building new facilities; and
evaluating the potential for profitably operating at least two associated commercial activities;

25. The system of claim 1, wherein said association formation and management module includes means for generating a report for potential developers of the selected site.

26. The system of claim 25, wherein the report is in the form of a hard copy, tape, or disc.

27. The system of claim 25, wherein the report is recorded on a media capable of reproduction for visible evaluation by a developer.

28. The method of claim 15, further including the step of generating a report for potential developers.

29. The method of claim 28, wherein the report is in the form of a hard copy, tape, or disc.

30. The method of claim 28, wherein the report is recorded on a media capable of reproduction for visible evaluation by a developer.
